(19) United States
(12) Patent Application Publication
(10) Pub. No.: US 2025/0237276 A1
(43) Pub. Date: Jul. 24, 2025

(54) PORTABLE WINCH

(71) Applicant: Warn Industries, Inc., Clackamas, OR (US)

(72) Inventors: Eric Vaughn, Milwaukie, OR (US); Doug Calvert, Clackamas, OR (US); Darren Fretz, Oregon City, OR (US); Michael Hojnacki, Clackamas, OR (US); Bryon Borntrager, Portland, OR (US)

(21) Appl. No.: 19/033,814

(22) Filed: Jan. 22, 2025

Related U.S. Application Data
(60) Provisional application No. 63/624,130, filed on Jan. 23, 2024.

(51) Int. Cl. F16D 63/00; B66D 1/14; F16D 121/20

(52) U.S. Cl. CPC F16D 63/006; B66D 1/14; F16D 2121/20

(57) ABSTRACT

A portable winch includes a motor, a rotatable drum, and a clutch assembly configured to engage a gear assembly. In a default state, the motor is mechanically detached from the rotatable drum, and, in response to activation of the portable winch, the clutch assembly automatically engages the gear assembly, thereby mechanically attaching the motor to the rotatable drum.

### PRIORITY CLAIM AND CROSS-REFERENCE TO RELATED APPLICATIONS

This application claims priority to and the benefit of U.S. Provisional Patent App. No. 63/624,130, filed Jan. 23, 2024, titled PORTABLE WINCH, the entire contents of which are incorporated by reference herein in their entirety and relied upon.

### FIELD

The present disclosure relates generally to systems and methods for guiding, controlling, and pulling retractable ropes, lines, and cables.

### BACKGROUND

Winch technology allows a user to lift and move heavy and cumbersome objects. A vehicle recovery winch is one example of a winch, which is generally designed for large sport utility vehicles (“SUVs”) and trucks. In order to properly function, a user may be required to rigidly mount the vehicle recovery winch to a winch mount and/or a bumper of the vehicle. However, cross-over SUVs and smaller trucks may not provide the necessary mounting points, such as the proper bumper, to attach a vehicle recovery winch to the vehicle. In these instances, the user may be unable to use a vehicle recovery winch. Further, to the extent that the vehicle does include the necessary mounting points, the user may not want to permanently modify their vehicle solely to mount a vehicle recovery winch. Additionally, with vehicle recovery winches, the winch is limited in its transportability by the vehicle itself. Using the winch in off-road and/or remote locations may be difficult or impossible if the vehicle itself cannot access the particular location.

While certain portable pulling tools exist today, the current tools have several limitations; namely, these tools require external power (e.g., via an external electrical power source and extension cord or, alternatively, via an external mechanical power source coupled to the tool itself).

Improved winch systems that are not required to be attached to a vehicle and include self-contained power are therefore needed.

### SUMMARY

In light of the disclosure, and without limiting the scope of the invention in any way, in a first aspect of the present disclosure, which may be combined with any other aspect listed herein unless specified otherwise, an automatic clutch assembly includes an electro-mechanical solenoid having a shaft disposed therein, a pivot arm hingedly coupled to the electro-mechanical solenoid, and a clutch pin disposed perpendicular to the shaft and coupled to the pivot arm. The clutch pin is in an engaged position when the electro-mechanical solenoid is activated, and the clutch pin is in a disengaged position when the electro-mechanical solenoid is deactivated.

In a second aspect of the present disclosure, which may be combined with any other aspect listed herein unless specified otherwise, a first end of the pivot arm is coupled to the shaft of the electro-mechanical solenoid and a second end of the pivot arm is coupled to the clutch pin.

In a third aspect of the present disclosure, which may be combined with any other aspect listed herein unless specified otherwise, the shaft is extended from the electro-mechanical solenoid when the electro-mechanical solenoid is deactivated.

In a fourth aspect of the present disclosure, which may be combined with any other aspect listed herein unless specified otherwise, the shaft is retracted into the electro-mechanical solenoid when the electro-mechanical solenoid is activated.

In a fifth aspect of the present disclosure, which may be combined with any other aspect listed herein unless specified otherwise, the automatic clutch assembly further includes a spring to mechanically bias the clutch pin to the disengaged position when the electro-mechanical solenoid is deactivated.

In a sixth aspect of the present disclosure, which may be combined with any other aspect listed herein unless specified otherwise, the pivot arm rotates about a pin.

In a seventh aspect of the present disclosure, which may be combined with any other aspect listed herein unless specified otherwise, the clutch pin extends through an aperture of the automatic clutch assembly.

In an eighth aspect of the present disclosure, which may be combined with any other aspect listed herein unless specified otherwise, vertical translation of the shaft causes horizontal translation of the clutch pin.

In a ninth aspect of the present disclosure, which may be combined with any other aspect listed herein unless specified otherwise, the clutch pin includes a first end and a second end, and the first end is coupled to the pivot arm.

In a tenth aspect of the present disclosure, which may be combined with any other aspect listed herein unless specified otherwise, the second end of the clutch pin is a dovetail shape.

In an eleventh aspect of the present disclosure, which may be combined with any other aspect listed herein unless specified otherwise, an automatic clutch assembly includes a pivot arm coupled to an electro-mechanical solenoid, and a clutch pin having an engaged position and a disengaged position. In the engaged position, the clutch pin engages a gear assembly.

In a twelfth aspect of the present disclosure, which may be combined with any other aspect listed herein unless specified otherwise, the clutch pin extends through an aperture of the automatic clutch assembly to engage the gear assembly.

In a thirteenth aspect of the present disclosure, which may be combined with any other aspect listed herein unless specified otherwise, the clutch pin engages a rotating gear of the gear assembly when the clutch pin is in the engaged position.

In a fourteenth aspect of the present disclosure, which may be combined with any other aspect listed herein unless specified otherwise, the clutch pin includes a first end coupled to the pivot arm and a second end. The second end engages the rotating gear of the gear assembly when the clutch pin is in the engaged position.

In a fifteenth aspect of the present disclosure, which may be combined with any other aspect listed herein unless specified otherwise, the rotating gear of the gear assembly includes a plurality of notches.

In a sixteenth aspect of the present disclosure, which may be combined with any other aspect listed herein unless specified otherwise, the second end of the clutch pin engages one of the plurality of notches of the rotating gear when the clutch pin is in the engaged position.

In a seventeenth aspect of the present disclosure, which may be combined with any other aspect listed herein unless specified otherwise, when the second end of the clutch pin engages one of the plurality of notches of the rotating gear, the one of the plurality of notches is configured to translate a rotational force on the rotating gear to a lateral force on the clutch pin.

In an eighteenth aspect of the present disclosure, which may be combined with any other aspect listed herein unless specified otherwise, when the lateral force is above a predetermined threshold load, the clutch pin maintains engagement with the rotating gear.

In a nineteenth aspect of the present disclosure, which may be combined with any other aspect listed herein unless specified otherwise, when the lateral force is below the predetermined threshold load, the clutch pin disengages from the rotating gear.

In a twentieth aspect of the present disclosure, which may be combined with any other aspect listed herein unless specified otherwise, the second end of the clutch pin is a dovetail shape.

In a twenty-first aspect of the present disclosure, which may be combined with any other aspect listed herein unless specified otherwise, a portable winch includes a reaction component, and a cable configured to unwind from a rotatable drum. When the cable over extends from the rotatable drum, the cable engages the reaction component, causing the portable winch to deactivate.

In a twenty-second aspect of the present disclosure, which may be combined with any other aspect listed herein unless specified otherwise, the reaction component includes a first position and a second position, and the portable winch is deactivated when the reaction component is disposed in the second position.

In a twenty-third aspect of the present disclosure, which may be combined with any other aspect listed herein unless specified otherwise, the reaction component is biased to the first position.

In a twenty-fourth aspect of the present disclosure, which may be combined with any other aspect listed herein unless specified otherwise, the portable winch deactivates when the reaction component engages the switch when the reaction component is disposed in the second position.

In a twenty-fifth aspect of the present disclosure, which may be combined with any other aspect listed herein unless specified otherwise, the cable engages the reaction component and forces the reaction component to engage the switch when the reaction component is disposed in the second position.

In a twenty-sixth aspect of the present disclosure, which may be combined with any other aspect listed herein unless specified otherwise, the reaction component is a flexible plastic component.

In a twenty-seventh aspect of the present disclosure, which may be combined with any other aspect listed herein unless specified otherwise, the reaction component is a spring.

In a twenty-eighth aspect of the present disclosure, which may be combined with any other aspect listed herein unless specified otherwise, the cable over extends from the rotatable drum when the cable winds backwards onto the rotatable drum.

In a twenty-ninth aspect of the present disclosure, which may be combined with any other aspect listed herein unless specified otherwise, the reaction component includes a first side and a second side.

In a thirtieth aspect of the present disclosure, which may be combined with any other aspect listed herein unless specified otherwise, the cable engages the first side of the reaction component when the cable over extends from the rotatable drum.

In a thirty-first aspect of the present disclosure, which may be combined with any other aspect listed herein unless specified otherwise, a portable winch includes a fairlead pivotably coupled to a housing of the portable winch, and a cable configured to extend through the fairlead and wind onto a rotatable drum. In response to a force on a front surface of the fairlead, the fairlead pivots and engages a switch to deactivate the portable winch.

In a thirty-second aspect of the present disclosure, which may be combined with any other aspect listed herein unless specified otherwise, the fairlead includes a first position and a second position.

In a thirty-third aspect of the present disclosure, which may be combined with any other aspect listed herein unless specified otherwise, the fairlead is biased toward the first position, and the portable winch can be activated when the fairlead is in the first position.

In a thirty-fourth aspect of the present disclosure, which may be combined with any other aspect listed herein unless specified otherwise, the fairlead includes a magnet configured to engage a plate in the housing, and the fairlead is biased toward the first position via a magnetic force between the plate and the magnet.

In a thirty-fifth aspect of the present disclosure, which may be combined with any other aspect listed herein unless specified otherwise, the fairlead pivots about a pin in response to the force on the front surface of the fairlead overcoming the magnetic force between the plate and the magnet.

In a thirty-sixth aspect of the present disclosure, which may be combined with any other aspect listed herein unless specified otherwise, the cable includes a stopper configured to provide the force on the front surface of the fairlead.

In a thirty-seventh aspect of the present disclosure, which may be combined with any other aspect listed herein unless specified otherwise, the portable winch includes a housing stop configured to prevent the fairlead from over rotating and damaging the switch.

In a thirty-eighth aspect of the present disclosure, which may be combined with any other aspect listed herein unless specified otherwise, the fairlead includes a slot configured to receive the magnet.

In a thirty-ninth aspect of the present disclosure, which may be combined with any other aspect listed herein unless specified otherwise, the fairlead extends from an aperture of the portable winch.

In a fortieth aspect of the present disclosure, which may be combined with any other aspect listed herein unless specified otherwise, the fairlead pivots into the portable winch in response to the force on the front surface of the fairlead.

In a forty-first aspect of the present disclosure, which may be combined with any other aspect listed herein unless specified otherwise, a portable winch includes a motor, a rotatable drum, and a clutch assembly configured to engage a gear assembly. In a default state, the motor is mechanically detached from the rotatable drum, and, in response to activation of the portable winch, the clutch assembly automatically engages the gear assembly, thereby mechanically attaching the motor to the rotatable drum.

In a forty-second aspect of the present disclosure, which may be combined with any other aspect listed herein unless specified otherwise, a load is exerted on the portable winch when the portable winch is no longer activated.

In a forty-third aspect of the present disclosure, which may be combined with any other aspect listed herein unless specified otherwise, the clutch assembly automatically disengages the gear assembly when the load is below a predetermined threshold load.

In a forty-fourth aspect of the present disclosure, which may be combined with any other aspect listed herein unless specified otherwise, the clutch assembly maintains engagement with the gear assembly when the load is above a predetermined threshold load.

In a forty-fifth aspect of the present disclosure, which may be combined with any other aspect listed herein unless specified otherwise, the clutch assembly automatically disengages the gear assembly when the load falls below the predetermined threshold load.

In a forty-sixth aspect of the present disclosure, which may be combined with any other aspect listed herein unless specified otherwise, the clutch assembly includes an electro-mechanical solenoid having a shaft disposed therein, a pivot arm hingedly coupled to the electro-mechanical solenoid, and a clutch pin disposed perpendicular to the shaft and coupled to the pivot arm. The clutch pin engages the gear assembly when the electro-mechanical solenoid is activated, and the clutch pin is disengaged from the gear assembly when the electro-mechanical solenoid is deactivated.

In a forty-seventh aspect of the present disclosure, which may be combined with any other aspect listed herein unless specified otherwise, a first end of the pivot arm is hingedly coupled to the electro-mechanical solenoid and a second end of the pivot arm is coupled to the clutch pin.

In a forty-eighth aspect of the present disclosure, which may be combined with any other aspect listed herein unless specified otherwise, the portable winch further includes a spring to mechanical bias the clutch pin to the disengaged position when the electro-mechanical solenoid is deactivated.

In a forty-ninth aspect of the present disclosure, which may be combined with any other aspect listed herein unless specified otherwise, the portable winch further includes a reaction component, and a cable configured to unwind from the rotatable drum. When the cable over extends from the rotatable drum, the cable engages the reaction component, causing the portable winch to deactivate.

In a fiftieth aspect of the present disclosure, which may be combined with any other aspect listed herein unless specified otherwise, the portable winch further includes a switch, and the portable winch deactivates when the reaction component engages the switch.

In a fifty-first aspect of the present disclosure, which may be combined with any other aspect listed herein unless specified otherwise, the portable winch further includes a fairlead rotatably coupled to a housing of the portable winch, and a cable configured to extend through the fairlead and wind onto the rotatable drum. In response to a force on a front surface of the fairlead, the fairlead rotates and engages a switch to deactivate the portable winch.

In a fifty-second aspect of the present disclosure, which may be combined with any other aspect listed herein unless specified otherwise, the fairlead includes a first position and a second position.

In a fifty-third aspect of the present disclosure, which may be combined with any other aspect listed herein unless specified otherwise, the fairlead is biased toward the first position, and the portable winch can be activated when the fairlead is in the first position.

In a fifty-fourth aspect of the present disclosure, which may be combined with any other aspect listed herein unless specified otherwise, the portable winch further includes a battery configured to provide power to the motor.

In a fifty-fifth aspect of the present disclosure, which may be combined with any other aspect listed herein unless specified otherwise, the portable winch includes a housing have a first side, a second side, a top portion, and a bottom portion; a rotatable drum disposed within a rear portion of the bottom portion of the housing; and a motor assembly disposed within a front portion of the bottom portion of the housing. The motor assembly is in-line with the rotatable drum and a fairlead.

In a fifty-sixth aspect of the present disclosure, which may be combined with any other aspect listed herein unless specified otherwise, the portable winch further includes a belt drive reduction and a gear train assembly, wherein the belt drive reduction is disposed within the first side of the housing, and the gear train assembly is disposed within the second side of the housing.

In a fifty-seventh aspect of the present disclosure, which may be combined with any other aspect listed herein unless specified otherwise, in a default state, a motor of the motor assembly is mechanically detached from the rotatable drum, and, in response to activation of the portable winch, a clutch assembly automatically engages a gear assembly, thereby mechanically attaching the motor to the rotatable drum.

In a fifty-eighth aspect of the present disclosure, which may be combined with any other aspect listed herein unless specified otherwise, a load is exerted on the portable winch when the portable winch is no longer activated.

In a fifty-ninth aspect of the present disclosure, which may be combined with any other aspect listed herein unless specified otherwise, the clutch assembly automatically disengages the gear assembly when the load is below a predetermined threshold load.

In a sixtieth aspect of the present disclosure, which may be combined with any other aspect listed herein unless specified otherwise, the clutch assembly maintains engagement with the gear assembly when the load is above a predetermined threshold load.

Additional features and advantages of the disclosed devices, systems, and methods are described in, and will be apparent from, the following Detailed Description and the Figures. The features and advantages described herein are not all-inclusive and, in particular, many additional features and advantages will be apparent to one of ordinary skill in the art in view of the figures and description. Also, any particular embodiment is not required to have all of the advantages listed herein. Moreover, it should be noted that the language used in the specification has been selected for readability and instructional purposes, and not to limit the scope of the present subject matter.

### BRIEF DESCRIPTION OF THE FIGURES

Understanding that figures depict only typical embodiments of the invention and are not to be considered to limit the scope of the present disclosure, the present disclosure is described and explained with additional specificity and detail through the use of the accompanying figures. The figures are listed below.

FIG. 1 illustrates a perspective view of a portable winch, according to an example embodiment of the present disclosure.

FIG. 2A illustrates a side view of a portable winch, according to an example embodiment of the present disclosure.

FIG. 2B illustrates a top-down view of a portable winch, according to an example embodiment of the present disclosure.

FIGS. 3A and 3B illustrate perspective views of an internal winch assembly of a portable winch, according to an example embodiment of the present disclosure.

FIGS. 4A and 4B illustrate cross-sectional views of a portable winch when an automatic power out shut off feature is deactivated, according to an example embodiment of the present disclosure.

FIGS. 5A and 5B illustrate cross-sectional views of a portable winch when an automatic power out shut off feature is activated, according to an example embodiment of the present disclosure.

FIG. 6 illustrates a cross-sectional perspective view of a portable winch having an automatic power in shut off feature, according to an example embodiment of the present disclosure.

FIG. 7A illustrates a cross-sectional view of a portable winch when an automatic power in shut off feature is deactivated, according to an example embodiment of the present disclosure.

FIG. 7B illustrates a cross-sectional view of a portable winch when an automatic power in shut off feature is activated, according to an example embodiment of the present disclosure.

FIG. 8A illustrates an automatic clutch assembly in a disengaged state and a gear train assembly of a portable winch, according to an example embodiment of the present disclosure.

FIG. 8B illustrates an automatic clutch assembly in an engaged state and a gear train assembly of a portable winch, according to an example embodiment of the present disclosure.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specific the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent”). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Portable winches generally have an engaged state and a disengaged state. The disengaged state is commonly referred to as a free-spool state. When a portable winch is in the free-spool state, the portable winch drum is mechanically detached from the motor. Accordingly, in the free-spool state, the user can pull the rope from the winch to, for example, attach the rope to an object without having to power or activate the winch. The free-spool state advantageously allows the user to pull a desired amount of rope from the portable winch for the rigging process with minimal physical effort. In contrast, the portable winch drum is mechanically attached to the motor in the engaged state. When a user activates the portable winch with a power in or a power out operation in the engaged state, the portable winch transmits torque and rotates the drum. Depending on the direction of rotation of the drum, rope is either wound onto or unwound from the drum. In the engaged state, the user cannot readily pull the rope from the portable winch, unlike when the portable winch is the free-spool state.

Typically, the default state of a winch is the engaged state. Generally, the user must perform a specific action to adjust the portable winch from the engaged state to the free-spool state. While this may require any one of a number of actions, examples include turning a handle, a dial, or pressing a button on a remote. Often, this action causes the clutch of the portable winch to disengage the gear assembly. When the clutch of the portable winch is engaged with the gear assembly, the portable winch is in the engaged state. When the clutch is disengaged with the gear assembly, the portable winch is in the free-spool state. Likewise, the user has to take an action to adjust the portable winch from the free-spool state back to the engaged state (or cause the clutch to engage the gear assembly).

In an example, this action may be the same action required to initially adjust the portable winch from the engaged state to the free-spool state. However, such process includes unnecessary steps that may confuse or frustrate the user. For example, the user may want to pull out and extend the rope during the rigging process without activating the motor to connect the rope to an object. However, by default, the portable winch may be in the engaged state, preventing the user from unwinding the rope. In another example, the portable winch may be in the free-spool state, and the user may forget to adjust the portable winch back to the engaged state before activating the power in or power out operations. Without the clutch engaging the gear assembly, the motor cannot provide torque to the drum. Accordingly, the rope will not wind or unwind from the portable winch drum when the user tries to activate the power in or power out operations. This process may be simplified to allow users that are less knowledgeable about winch technology to easily operate a portable winch.

The portable winch of the present disclosure includes two states, an engaged state and a free-spool state. When the portable winch is in the free-spool state, the portable winch drum is mechanically detached from the motor, allowing a user to pull the rope from the portable winch without having to power the winch. In the engaged state, the winch drum is mechanically attached to the motor. When the user activates the portable winch in the engaged state, the portable winch can transmit torque and rotate the drum. In the engaged state, a user cannot pull the rope from the portable winch. The default state of the portable winch of the present disclosure is the free-spool state. Accordingly, in the default state, the user can pull the rope from the portable winch without having to power the winch. In other words, a user action is not required to adjust the portable winch to the free-spool state. The user would not be require to, for example, disengage a clutch in order to adjust the portable winch to the free-spool state. The portable winch is in the free-spool state by default, which allows the user to manually unwind the rope for the rigging process.

Further, the portable winch includes an automatic clutch assembly. The automatic clutch assembly automatically adjusts the portable winch from the free-spool state to the engaged state when the user activates the portable winch with a power in or power out operation. Specifically, the power in or power out operations cause the automatic clutch assembly to engage a gear train assembly, causing torque to be transmitted to the drum of the portable winch. In an illustrative example, the user first unwinds the rope from the portable winch in the free-spool state. Then, once the rigging process is complete, the user activates a power in or power out operation without having to adjust the portable winch to the engaged state. Instead, the portable winch automatically adjusts from the free-spool state to the engaged state when the user activates the power in or power out operation. Depending on the operation, the motor then rotates the drum to wind or unwind the rope onto the rotatable drum.

When the user stops activating the portable winch, the portable winch may have several different responses depending on the load exerted on the portable winch. Namely, in one scenario, the user stops activating the portable winch and there is no load exerted on the portable winch. In other words, there is no tension on the rope of the portable winch. In such situation, the automatic clutch assembly automatically disengages the gear train assembly. When the automatic clutch assembly disengages the gear train assembly, the portable winch reverts back to a free-spool state as the portable winch existed prior to the user activating the portable winch.

In another situation, when the user stops activating the portable winch, a load is exerted on the portable winch that is below a predetermined threshold load. In this situation, the automatic clutch assembly, again, automatically disengages the gear train assembly. When the automatic clutch assembly disengages the gear train assembly, the portable winch reverts back to a free-spool state. Thus, when a load is exerted on the portable winch that is below a predetermined threshold load, the portable winch functions similar to the prior situation in which there was no load exerted on the portable winch when the user stopped activating the portable winch.

In another situation, a load is exerted on the portable winch that is at or above the predetermined threshold load when the user stops activating the portable winch. When the load exerted on the portable winch is above the predetermined threshold load, the automatic clutch assembly will remain in the engaged position until the load falls below the predetermined threshold load. Thus, the automatic clutch assembly only adjusts back to the free-spool state if the load exerted on the portable winch is below the predetermined threshold load. This provides added safety measures for the portable winch. In one example, a user attaches the rope to an object. Then, the user activates the portable winch with a power in operation, pulling the object up an incline. When the user stops activating the portable winch, the rope may still be holding the object in the same position, providing tension on the rope and exerting a load on the portable winch. The portable winch remains in the engaged position, holding the object in the same position until the load on the portable winch falls below the predetermined threshold load. At which point, the automatic clutch assembly will disengage the gear train assembly and the portable winch will revert back to the free-spool state.

The configuration and features of the portable winch simplify the winching process. Rather than requiring a user to switch back and forth from the engaged state to the free-spool state, the automatic winch assembly performs the required actions for the user. As introduced above, the portable winch is in the free-spool state by default. When the user activates the portable winch with a power in or a power out operation, the portable winch automatically adjusts to the engaged state. Then, when the user stops activating the portable winch, the portable winch responds dependent on whether (and to what extent) a load is exerted on the portable winch. If no load is exerted on the portable winch, the portable winch adjusts back to the free-spool state. If the load exerted on the portable winch is below a predetermined threshold load, the portable winch adjusts back to the free-spool state. If the load exerted on the portable winch is above a predetermined threshold load, the portable winch remains in the engaged state. Once the load decreases below the predetermined threshold load, the portable winch reverts back to the free-spool state.

The disclosed portable winch may be especially advantageous for novice or first-time users because the user is not required to understand the mechanics of the portable winch. The user is also not required to adjust the portable winch between the engaged state and the free-spool state. Instead, the portable winch of the present disclosures provides a default state that allows the user to easily attach the rope to an object. Also, novice users may be more likely to use a portable winch. For example, as introduced above, users may have to permanently modify their vehicles to mount a winch. Such users that are willing to modify their vehicle may be more likely to understand the mechanics of a winch and appreciate the functions of the engaged and free-spool states. Thus, users drawn to a portable winch may be less knowledgeable about winch technology. However, the portable winch of the present disclosure provides an intuitive process.

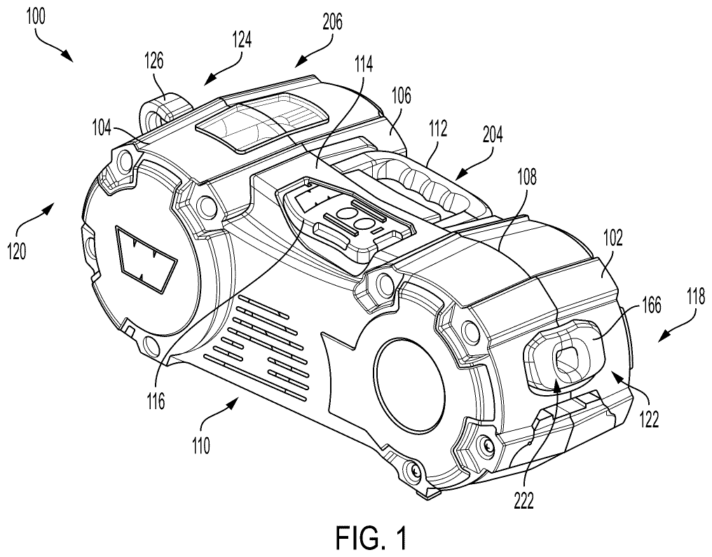

FIG. 1 illustrates a perspective view of a portable winch, according to an example embodiment of the present disclosure. The portable winch 100 includes a housing 102 having a first side 104 and a second side 106. The first side 104 of the housing 102 is mechanically coupled to the second side 106 of the housing 102 via, for example, bolts, rivets, screws, or a snap fit connection. In FIG. 1, the first side 104 of the housing 102 and the second side 106 of the housing 102 meet at a scam 108, which runs around the housing 102. The first side 104 of the housing 102 and the second side 106 of the housing 102 are coupled such that the housing 102 can be disassembled and reassembled, allowing a user to access the internal winch assembly to, for example, repair and/or replacement various components. In an embodiment, the first side 104 of the housing 102 includes a vent 110. The vent 110 includes a plurality of elongated apertures configured to provide air flow through the housing 102. Such air flow may function to cool the internal winch assembly of the portable winch 100. In other embodiments, the characteristics of the plurality of elongated apertures may be varied, including the shape, position, and number. While not shown in FIG. 1, the second side 106 of the housing may also include a vent having a plurality of elongated apertures to provide additional air flow for the internal winch assembly.

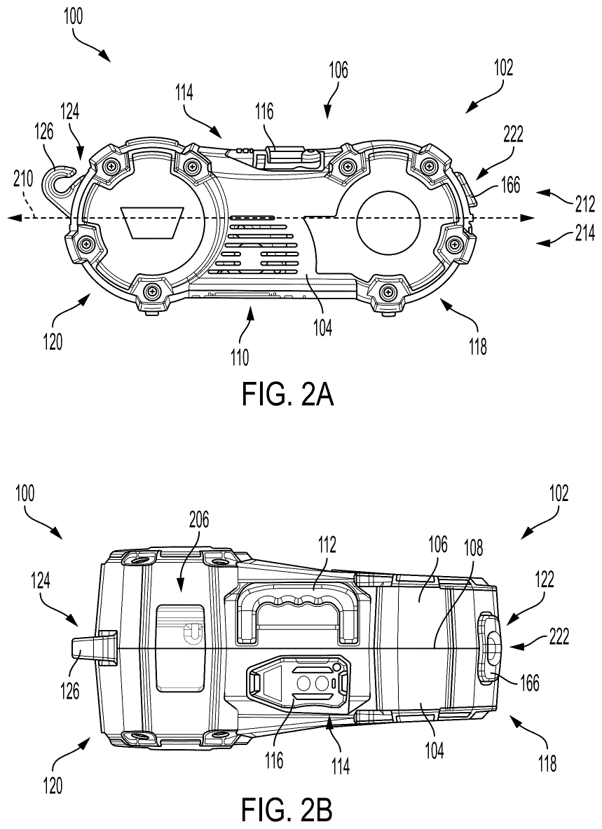

The portable winch 100 further includes a front portion 118 and a rear portion 120. As shown in FIG. 1, when the first side 104 of the housing 102 and the second side 106 of the housing 102 are mechanically coupled, a first aperture 122 is formed on the front portion 118 of the housing 102, and a fairlead 166 is disposed within and extends from the first aperture 122. The fairlead 166 includes a fairlead aperture 222. The fairlead 166 is configured to guide movement of a rope as it is wound onto or unwound from the drum (not shown). Thus, while in operation, the rope (not shown) extends through the fairlead aperture 222. In an example embodiment, the edges of the fairlead 166 surrounding the fairlead aperture 222 may be chamfered (e.g., curved away from an interior of the portable winch 100). With a chamfered configuration, the fairlead aperture 222 provides a smoother surface to reduce wear on the rope as it passes through. A second aperture 124 is formed on the rear portion 120 of the housing 102. The second aperture 124 is more clearly illustrated in FIG. 2B. An anchor hook 126 extends from the second aperture 124. As described in more detail below, the portable winch 100 may use the rope and the anchor hook 126 while in operation.

The portable winch 100 further includes a handle 112 along a top side of housing 102, having a stored position and a carry position. In FIG. 1, the handle 112 is in the stored position. The handle 112 provides a structure for carrying the portable winch 100. As shown in FIGS. 1 and 2B, the handle 112 may include a plurality of ridges 204 on a bottom surface of the handle 112. When the handle 112 is in the stored position, the plurality of ridges face toward the seam 108 of the portable winch 100. The plurality of ridges 204 are configured to conform to a user's fingers. In an embodiment, a first magnet is disposed within the handle 112. The first magnet engages a corresponding second magnet disposed on or within the housing 102. The first magnet and the second magnet attract to each other via a magnetic force. Such force biases the handle 112 to the stored position on the housing 102. As shown in FIG. 1, the handle 112 lays flat against the housing 102 in the stored position. In this position, the handle 112 is less likely to interfere with the portable winch 100. Further, the handle 112 is less likely to contact the surrounding environment when stored. To adjust the handle 112 into the carry position, a user rotates the handle 112 to overcome the attraction force between the first and second magnets.

The portable winch 100 may further include a receiving structure 114 disposed on the first side 104 of the housing 102. The receiving structure 114 is configured to receive a remote control 116. In FIG. 1, the receiving structure 114 is disposed on the first side 104 of the housing 100. However, the receiving structure 114 may be positioned in any one of a number of ways on, or within, the housing 102. In one example, the user of the portable winch 100 may provide input (e.g., instructions) via wireless communication with the remote control 116. The user may interface with the remote control 116 in order to operate the portable winch 100. However, the remote control 116 may be easily misplaced. By providing the receiving structure 114 on the housing 102, the remote control 116 may be stored concurrently with the portable winch 100. In another embodiment, the remote control 116 may be replaced with a mobile device. For example, the user may have a user interface, or application, on their mobile device to operate the portable winch 100.

As described in more detail below, the portable winch 100 may be activated with a power out or a power in operation. However, the user may activate the portable winch 100 for too long. Depending on the operation, the portable winch 100 may be damaged, or the rope may wind backwards and tangle within the housing 102 of the portable winch 100. Thus, the user should avoid such situations and monitor the portable winch 100. To allow the user to more easily monitor the portable winch 100, the portable winch 100 may further include a window 206 disposed on the rear portion 120 of the housing 102. Based on the position of the window 206, the user can monitor the internal winch assembly and the rope of the portable winch 100 to avoid, for example, powering out the portable winch 100 for too long of a period or to identify an undesirable tangle on the drum. With such added ability to monitor the portable winch 100, the user is less likely to activate the portable winch 100 for too long.

While not shown in FIG. 1, the portable winch 100 may further include a battery disposed within the front portion 118 under the fairlead 166 of the housing 102. Battery positioning at the front portion 118 is intended to counter-balance other heavy components within the portable winch 100, such as internal winch assembly 128 (as described in greater detail herein). Often times, access to electricity may not be available (e.g., when winching in remote locations). Accordingly, the battery allows the user to operate the portable winch 100 without, for example, plugging the portable winch 100 into a wall outlet or connecting the portable winch 100 to a vehicle's electrical system. Instead, the battery provides power to the motor of the portable winch 100 to function. As introduced above, the housing 102 of the portable winch 100 can be disassembled and reassembled. Thus, the battery may be rechargeable. In an illustrative example, the battery is fully charged and disposed within the housing 102 of the portable winch 100. After extended use, the battery may deplete and be unable to provide sufficient power to the motor of the portable winch 100. In response, the user may detach the first side 104 of the housing 102 from the second side 106 of the housing 102 and remove the battery. The battery may be recharged with, for example, a docking station. The docking station may attach to a wall outlet to accept and charge the battery. Once sufficiently charged, the user can place the battery back within the housing 102. With a charged battery, the portable winch can again be used. In another embodiment, the battery may be combined with other features of the portable winch 100. For example, the user's mobile device capable of operating the portable winch 100 may also provide a visual indication of the battery's charge. It should be appreciated that the battery disclosed herein may additionally be used with other power tools. For example, the battery that is used with portable winch 100 can be removed and installed onto another tool, such as a cordless drill, for powering that tool.

Additional views of the portable winch 100 described in reference to FIG. 1 are shown in FIGS. 2A and 2B. For example, FIG. 2A illustrates a side view of a portable winch, according to an example embodiment of the present disclosure. FIG. 2B illustrates a top-down view of a portable winch, according to an example embodiment of the present disclosure.

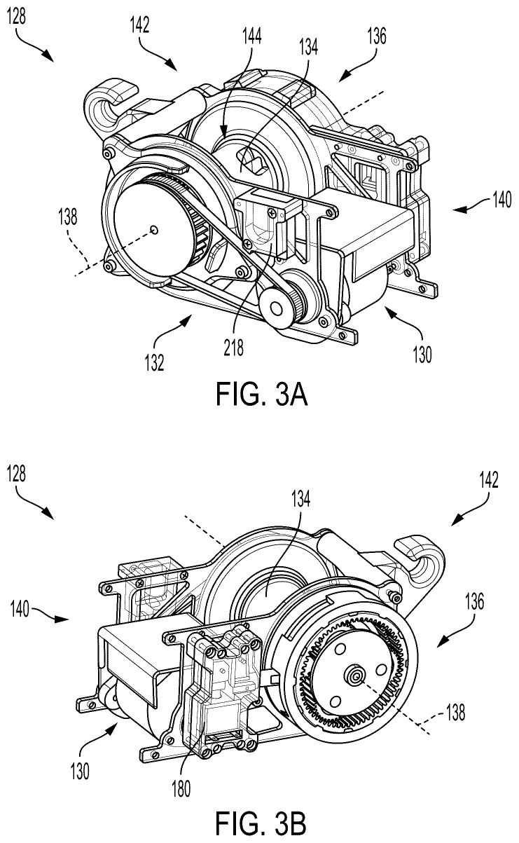

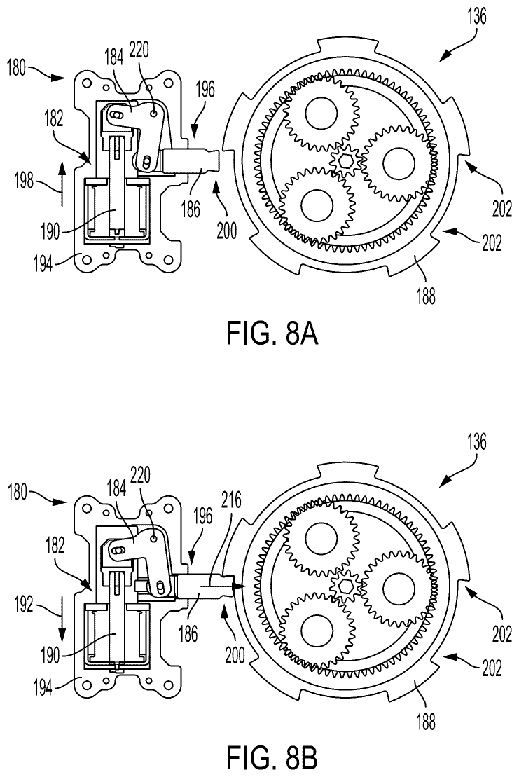

FIGS. 3A and 3B illustrate perspective views of an internal winch assembly of a portable winch, according to an example embodiment of the present disclosure. The internal winch assembly 128 may include a clutch assembly 180 and an inclinometer 218. The clutch assembly 180 is detailed in reference to FIGS. 8A and 8B. The inclinometer 218 is configured to measure the orientation of the portable winch 100. Depending on the orientation of the portable winch 100, the functions of the portable winch 100 may be limited. For example, the user may orient the portable winch 100 vertically and attempt to operate the portable winch 100 as a hoist. In response, the inclinometer 218 would measure the change of orientation and prevent the user from activating the power in or power out operations. In another embodiment, the portable winch 100 may limit the pulling capacity of, for example, the power in operation. As the orientation of the portable winch 100 changes, the inclinometer 218 would measure the orientation. In response, the portable winch 100 could limit the user to specific operations or only provide a portion of the load capacity.

The internal winch assembly 128 may further include a motor assembly 130, a belt-drive reduction 132, a drum 134, and a gear train assembly 136. The motor assembly 130 and gear train assembly 136 are each coupled to the drum 134 of the portable winch 100 in order to rotate the drum 134 around a central axis 138. In FIG. 3A, the motor assembly 130 is positioned at a front portion 140 of the internal winch assembly 128 and the gear train assembly 136 and the belt-drive reduction 132 are positioned at a rear portion 142 of the internal winch assembly 128. The drum 134 is coupled to the motor assembly 130 through the belt-drive reduction 132, which is coupled to the motor assembly 130 through an interior of a cylindrical portion of the drum 134.

While not shown in FIGS. 3A and 3B, the internal winch assembly 128 includes a controller. The controller is typically positioned within the housing of the portable winch. The controller may be an electronic controller (such as a microcontroller) and may control a speed of the motor within the motor assembly 130. In one example, the user of the portable winch provides input (e.g., instructions) to the controller to operate the portable winch. As previously introduced, the user may use a remote control 116 that wirelessly communicates with the controller. In other embodiments, the portable winch may include inputs (e.g., buttons) on the housing to control the controller and the speed of the motor within the motor assembly 130.

In one example operation of the portable winch, the motor assembly 130 may drive the drum 134 to rotate around the central axis 138 in a first direction or a second direction. The second direction is opposite to the first direction. For example, the motor assembly 130 may be driven in the first direction in order to rotate the drum 134 around the central axis 138; similarly, the motor assembly 130 may be driven in the second direction opposite to the first direction in order to rotate the drum 134 around the central axis 138 in the second direction. In one example, a rope (e.g., cable) may be wound around a smooth, outer surface 144 of the drum 134 in order to perform pulling operations of the portable winch. In another example, the outer surface 144 of the drum 134 may include a plurality of grooves that accept and organize the rope as the rope is wound onto the drum 134. In some examples, the rope may include a hook in order to increase an case of attachment of the rope to an object (e.g., a vehicle) to perform pulling operations. Depending on the application, the rope may be any number of lengths. In one embodiment, the rope may have a length of 50 feet and create five layers when fully wound around the drum 134.

Further, the various components of the internal winch assembly 128 may be positioned to balance the portable winch 100. For example, turning back to FIG. 1, the rope extends from the front portion 118. This rope may also be referred to as the fairlead rope. The anchor hook 126 is located on the rear portion 120. In operation, the user may connect the fairlead rope to an object. Another rope (referred to as the anchor rope) can be used to connect the anchor hook 126 to an anchor point. When activated with the power in operation, the portable winch 100 undergoes a pulling force in opposite directions. Namely, the fairlead rope and the anchor rope exert opposite forces on the portable winch 100. Thus, depending on the height of the object and height of the anchor point, the portable winch 100 may elevate from the ground. Accordingly, the anchor hook 126 and the fairlead 166 may be referred to as the suspension points.

Without proper balance, the portable winch 100 is prone to twisting, rotating, and movement when elevated from the ground. This movement may lead to undesirable effects. For example, the portable winch 100 may impact the surrounding environment, leading to damage. Further, the portable winch 100 may rotate, causing either the anchor rope or fairlead rope to tangle. This may reduce the performance of the portable winch 100 or potentially cause an unsafe environment. Moreover, with movement, the anchor rope may detach from the anchor hook 126. Thus, it may be advantageous to balance the portable winch to reduce movement.

Referring to FIG. 2A, the portable winch 100 includes a horizontal axis 210. The horizontal axis 210 may also be referred to as the x-axis. The horizontal axis 210 roughly divides the portable winch 100 into a top portion 212 and a bottom portion 214. To reduce the portable winch 100 from rotating, the portable winch 100 is configured to have a low center of gravity, below the horizontal axis 210. For example, referring to FIGS. 3A and 3B, the motor assembly 130 often constitutes a significant portion of the weight of the internal winch assembly 128. Accordingly, the motor assembly 130 may be disposed within the bottom portion 214 of the portable winch 100 to provide a center of gravity below the horizontal axis 210. For the same reasons, the drum 134 may also be disposed toward the bottom portion 214 of the portable winch 100. Further, the motor assembly 130 placement may be a parallel shaft design. This allows a motor of the motor assembly 130 to be lower than the drum 134 but also in-line with the drum 134 and fairlead 166 (under the tensioned rope). This placement optimizes the center of gravity of the portable winch 100. When the motor is in-line with the rope and lower than the suspension points (the anchor hook 126 and the fairlead 166, each above the horizontal axis 210), the portable winch provides a more stable platform that is predictable and safer. This placement also contributes to the overall compactness and aesthetics of the portable winch.

The internal winch assembly 128 may also be balanced between the first side 104 and the second side 106 of the portable winch 100 (e.g., for balanced lifting via handle 112). Referring to FIGS. 3A and 3B, the belt-drive reduction 132 and the gear train assembly 136 are positioned on opposite sides of internal winch assembly 128. Further, the motor assembly 130 and drum 134 are positioned such that the weight of the motor assembly 130 and drum 134 is equally distributed between the first side 104 and the second side 106 of the portable winch.

The internal winch assembly 128 may also be constructed to provide various performance benefits. For example, the drum 134 is disposed within the rear portion 120 and the fairlead 116 disposed at the front portion 118 of the portable winch 100, opposite of the drum 134. Such configuration provides a low fleet angle. With a low fleet angle, the rope is more likely to wind around the drum 134 in an organized fashion with each layer winding onto the lower layer. Further, with the drum 134 positioned within the rear portion 120, closer to the anchor hook 126, the load path between the drum 134 and the anchor hook 126 is concentrated. A concentrated load path between the drum 134 and the anchor hook 126 allows the weight of the load bearing frame rails to be smaller, lighter, and stronger, leading various performance benefits.

### Automatic Power Out Shut Off

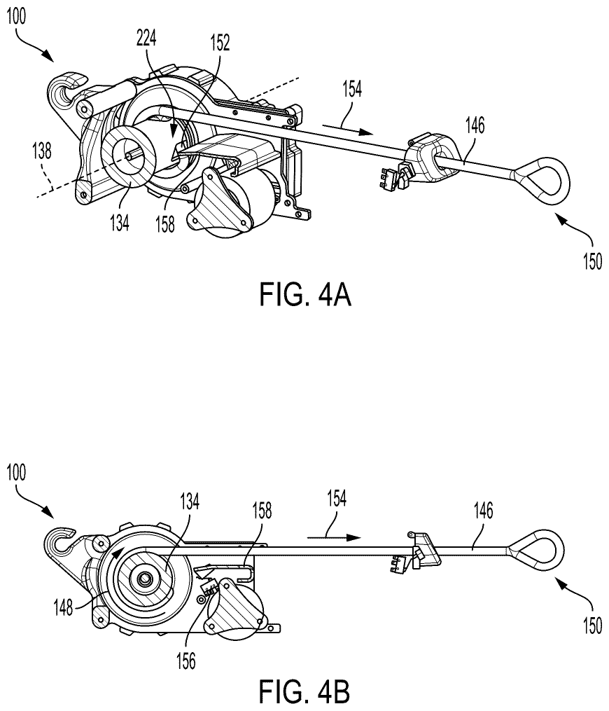

FIGS. 4A and 4B illustrate cross-sectional views of a portable winch, according to an example embodiment of the present disclosure. Referring to FIGS. 4A and 4B, the portable winch 100 includes a rope 146 having a first end 150 and a second end 152. The second end 152 of the rope 146 is attached to the drum 134. As shown in FIG. 4A, the drum 134 includes an aperture 224 that accepts and secures the second end 152 of the rope 146 to the drum 134. When activated by the user, the motor assembly may drive the drum 134 to rotate around a central axis 138 in a first direction. In one example, the drum 134 rotates about the central axis 138 in the first direction, or clockwise direction. The first direction is represented by an arrow 148 in FIG. 4B. As the drum 134 rotates in the first direction, the rope 146 unwinds from the drum 134, and the first end 150 of the rope 146 extends further away from the portable winch 100. The direction of the rope 146 extending is represented by an arrow 154. Because rope 146 is unwinding from the drum 134 and the first end 150 is extending away from the portable winch 100, this operation may be referred to as a power out operation.

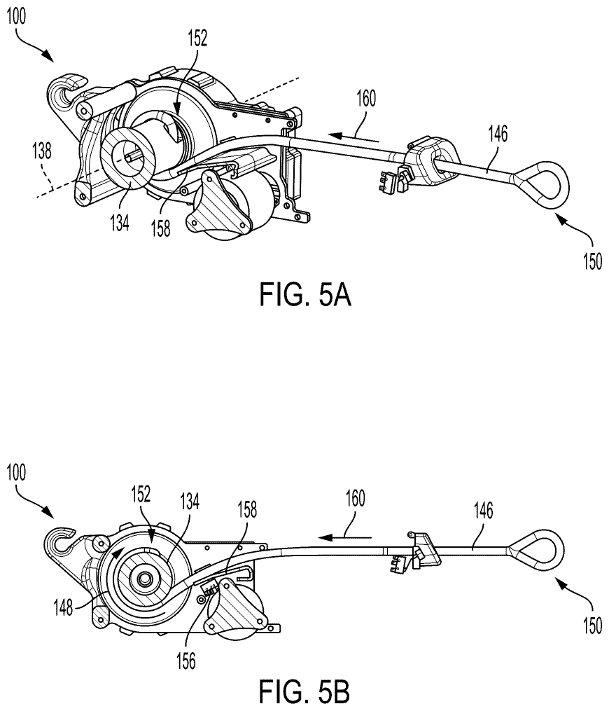

FIGS. 5A and 5B illustrate cross-sectional views of a portable winch, according to an example embodiment of the present disclosure. As introduced in FIGS. 4A to 4B, when activated by the user, the drum 134 may rotate around a central axis 138 in a first direction to unwind the rope 146. However, in FIG. 5A and 5B, a portable winch 100 is illustrated in which the user may have activated the portable winch 100 with a power out operation for too long. This may result in the portable winch 100 winding the rope 146 backwards onto the drum 134. In other words, as the user continues to power the portable winch 100 with the power out operation, the drum 134 continues to rotate in the first direction 148, or clockwise direction, until the rope 146 is wound backwards onto the drum 134. As shown, for example, in FIG. 5A, the drum 134 rotates, winding the rope 146 onto the drum 134. As the rope 146 is wound backward onto the drum 134, the first end 150 of the rope 146 is retracted toward the portable winch 100, represented by arrow 160 in FIGS. 5A and 5B. When a user rewinds the rope 146 onto the drum 134 of the portable winch 100, the rope 146 may tangle or contact and damage various components of the internal winch assembly. Thus, a user should avoid activating the portable winch 100 with the power out operation in order to avoid rewinding the rope 146 backward onto the drum 134.

However, a user may find it difficult to monitor the portable winch and avoid such situations with current portable winch technology. For example, as described in reference to FIG. 1, the portable winch includes a housing, which encases and protects the internal winch assembly. Although the housing provides various advantages (and is commonly included in a variety of winches), the housing often limits the user's view of the rope and the drum. Without a proper view of the rope and the drum, a user may find it difficult to determine when the rope is over-extended and about to be wound backwards onto the drum. In turn, the user may unintentionally activate the portable winch with a power out configuration for too long, which may lead to negative effects. In another example, to the extent that the housing does not obscure the user's view, the portable winch may be at an anchor point with the user on the opposite end of the rope without a view the winch. Also, the user may wirelessly control the portable winch and be too far to properly monitor the portable winch. These non-limiting examples demonstrate various situations in which the user may find it difficult to determine when to activate the portable winch.

Therefore, rather than require the user to determine when to activate the portable winch, the portable winch of the present disclosure includes an automatic power out shut off feature. By having an automatic power out shut off feature, the user does not need to worry about the portable winch powering out past the rope length and winding the rope onto the drum in the opposite direction. Instead, the portable winch automatically powers off when the rope begins to wind onto the drum in the opposite direction. Accordingly, the potentially undesirable effects of winding the rope onto the drum may be avoided.

Turning back to FIG. 5A and 5B, the portable winch 100 further includes a switch 156 and a reaction component 158. The reaction component 158 has an engaged and a disengage position. In FIG. 5A and 5B, the reaction component 158 is in the engaged positioned. While in the engaged positioned, the reaction component 158 engages the switch 156 to deactivate the power on operation. In FIG. 4A and 4B, the reaction component 158 is in the disengaged positioned. While in the disengaged positioned, the reaction component 158 does not engage the switch 156 and the power on operation is not deactivated. The disengaged position is the default position of the reaction component 158 of FIGS. 4A to 5B.

In an illustrative example, a user is not operating the portable winch 100. Thus, the reaction component 158 is in the disengaged position as shown in FIG. 4B. Then, the user activates the portable winch 100 with a power out operation to unwind the rope 146 from the drum 134. As the rope 146 unwinds from the drum 134, the first end 150 of the rope 146 extends away from the portable winch in the direction of arrow 154 in FIG. 4B. However, if the user over powers the portable winch 100, the rope 146 begins to wind onto the drum 134 in the opposite direction. The reaction component 158 remains in the disengaged position. As the rope 146 continues to wind backwards onto the drum 134, the rope 146 contacts the reaction component 158, forcing the reaction component 158 into the engaged position. As described above, the reaction component 158 engages the switch 156 to deactivate the portable winch 100 in the engaged position. In other words, a user can continue to activate the portable winch 100 with a power out configuration without worry of over extending the rope and winding the rope backwards onto the drum 134. Instead, as the rope 146 begins to rewind onto the drum 134, the reaction component 158 engages the switch 156 and the portable winch 100 is powered off.

In the embodiment of FIG. 4A to 5B, the reaction component 158 is a flexible plastic component configured to react like a spring. Thus, when the rope 146 is removed from the reaction component 158, the reaction component 158 restores to the default, disengaged position. It should also be appreciated that the reaction component 158 can be any one of a number of designs in various embodiments. For example, the reaction component 158 could comprise metal spring materials. The reaction component 158 may also be a tie rod mounted to a frame rail with a spring to return the reaction component 158 to the disengaged position.

### Automatic Power In Shut Off

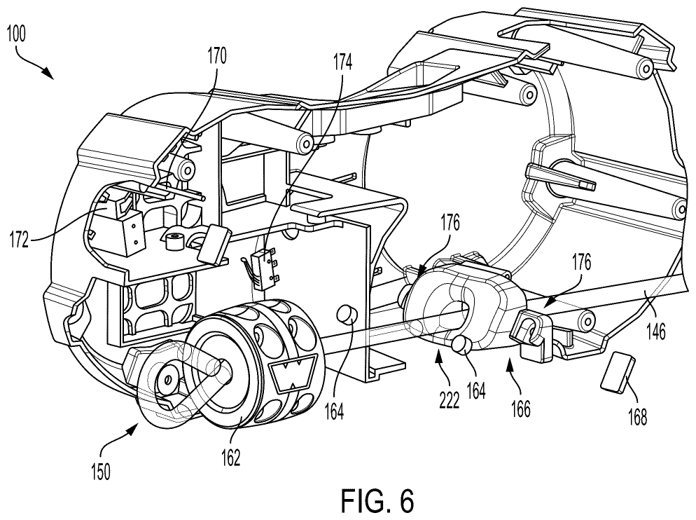

FIG. 6 illustrates a cross-sectional view of a portable winch, according to an example embodiment of the present disclosure. FIG. 6 does not illustrate several components of the portable winch, including, for example, the drum. However, the portable winch 100 shown in FIG. 6 functions the same as the portable winch 100 illustrated and as described in reference to FIGS. 4A to 5B. Namely, a user may activate the motor assembly to drive the drum to rotate around the central axis. A user may also activate the portable winch 100 with a power in operation. With such operation, the drum rotates around the central axis in a second direction to properly wind the rope 146 onto the drum. As the rope 146 is wound onto the drum, the first end 150 of the rope 146 retracts toward the portable winch 100. In one example, the first end 150 of the rope 146 is attached to an object. When the user activates the power in operation, the portable winch operates to pull the object toward the portable winch 100.

However, as introduced in reference to the power out operation, a user may activate the portable winch in the power in operation for too long, leading to undesirable effects. Therefore, rather than require the user determine when to stop activating the portable winch, the portable winch of the present disclosure includes an automatic power in shut off feature. By having an automatic power in shut off feature, the user does not need to worry about activating the portable winch too far with the power in operation. Instead, the portable winch automatically powers off when the fairlead is contacted by the first end of the rope.

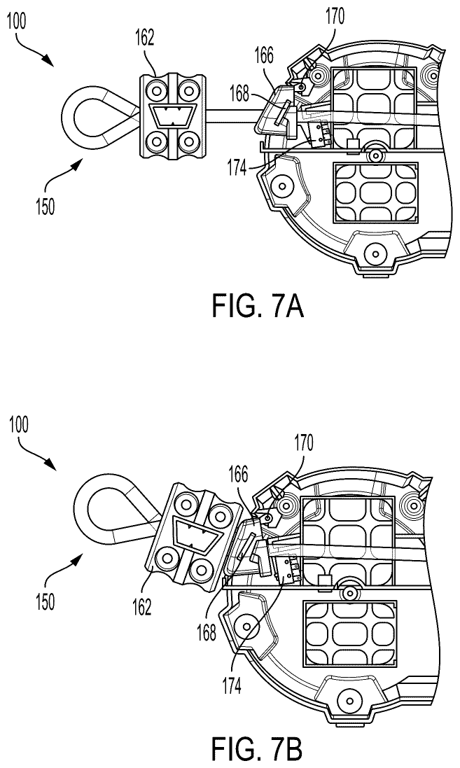

Referring to FIGS. 6 to 7B, the portable winch 100 includes a power-in switch 174 and a housing stop 172. The portable winch 100 further includes the fairlead 166 having a fairlead aperture 222 that the rope 146 extends through. The fairlead 166 has an engaged position and a disengaged position. In FIG. 7B, the fairlead 166 is in the engaged positioned. While in the engaged positioned, the fairlead 166 engages the power-in switch 174 to deactivate the power in operation. In FIG. 7A, the fairlead 166 is in the disengaged positioned. While in the disengaged positioned, the fairlead 166 does not engage the power-in switch 174 and the power in operation is not deactivated. The disengaged position is the default position of the fairlead 166.

The fairlead 166 also includes slots 176 configured to receive corresponding magnets 164. In one embodiment, the fairlead 166 is held in the default, disengaged position via the magnets 164 and a plate 168. Namely, as shown in FIG. 7A, the magnets 164 are attracted to the plate 168. To transition from the disengaged position to the engaged position, the force between the magnets 164 and the plate 168 must be overcome. Once the force between the magnets 164 and the plate 168 is overcome, the fairlead 166 rotates via a pin 170 until it contacts the power-in switch 174. When the fairlead 166 contacts the power-in switch 174, the power in operation is deactivated. The portable winch 100 may also include the housing stop 172, which prevents the fairlead 166 from damaging the power-in switch 174. Once the user powers the rope back out, the fairlead 166 automatically returns to the disengaged position. The return of the fairlead 166 to the disengaged position is caused by the attractive force between the magnets 164 and the plate 168.

In an illustrative example, a user is not operating the portable winch 100. Thus, the fairlead 166 is in the disengaged position. Then, the user activates the portable winch 100 with a power in operation to wind the rope 146 onto the drum. As the rope 146 winds onto the drum 134, the rope 146 retracts through the fairlead aperture 222 of the fairlead 166 of the portable winch 100. Accordingly, the first end 150 of the rope 146 and a stopper 162 also retract toward the portable winch 100. However, if the user over powers the portable winch 100, the stopper 162 contacts a front surface of the fairlead 166. As introduced, the rope 146 extends through the fairlead aperture 222. However, the size of the fairlead aperture 222 is configured to prevent the stopper 162 or, for example, a cable eye from extending through. When the stopper 162 contacts the fairlead 166, the attraction force between the magnets 164 and the plate 168 is overcome, causing the fairlead to rotatably pivot about the pin 170. In the embodiment of FIGS. 6 to 7B, the fairlead 166 is held in the disengaged position via the attraction force between the magnets 164 and the plate 168. However, in many embodiments, various springs could be used to replace the magnets 164 and achieve a similar biasing force as desired for the particular applications disclosed above.

With sufficient rotation, the fairlead 166 contacts the power-in switch 174, which automatically deactivates the power-in operation. Thus, rather than requiring a user to monitor the portable winch 100, the portable winch 100 deactivates the power in operation before the portable winch 100 is permanently damaged. Further, many portable winches are heavy and use a metal frame to mount the fairlead as a structural member. With an automatic power in shut off feature, the stopper 162 or first end of the rope does not exert large amounts of force on the fairlead 166. Instead, as described, the power in operation is deactivated when the stopper 162 contacts and rotates the fairlead 166. Accordingly, the amount of metal for the frame can be greatly reduced and is no longer a structural requirement.

### Automatic Clutch Assembly

FIGS. 8A and 8B illustrate cross-sectional views of a gear train assembly and a clutch assembly of a portable winch, according to an example embodiment of the present disclosure. The clutch assembly 180 includes a clutch assembly housing 194. The clutch assembly 180 further includes an electro-mechanical solenoid 182, a pivot arm 184, and a clutch pin 186. The electro-mechanical solenoid 182, the pivot arm 184, and the clutch pin 186 are each disposed within the clutch assembly housing 194 of the clutch assembly 180. Further, the clutch pin 186 is configured to extend through a clutch housing aperture 196 to engage with a rotating ring gear 188 of the gear train assembly 136.

Referring to FIG. 8A, the clutch assembly 180 is in the disengaged position and the clutch pin 186 is disengaged from the rotating ring gear 188. When the clutch assembly 180 is disengaged from the gear train assembly 136, the portable winch is in a free-spool state. In the embodiment of FIG. 8A, the clutch assembly 180 is in the disengaged position as a default position. In this default position, the portable winch is in a free-spool state. In the free-spool state, the drum of the winch is mechanically detached from the motor assembly, allowing the user to pull the rope, unwinding the rope off the drum without powering the winch. In FIG. 8B, the clutch assembly 180 is in the engaged position and the clutch pin 186 engages the rotating ring gear 188. In the engaged position, the drum is mechanically attached to the motor assembly.

When a user activates the portable winch with a power in or power out operation, the clutch assembly 180 automatically engages the gear train assembly 136, allowing the motor to transmit torque and rotate the drum of the portable winch. Specifically, the portable winch utilizes the electro-mechanical solenoid 182. In the default state, the portable winch is in the free-spool state and the electro-mechanical solenoid 182 is not energized. When the electro-mechanical solenoid 182 is not energized, a spring provides a mechanical bias to keep the clutch pin 186 disengaged from the rotating ring gear 188. In alternate embodiments, other types of mechanical biasing devices are implemented to ensure that the default state for clutch assembly 180 is in the disengaged position, and the portable winch is in the free-spool state.

When the user activates power in or power out operations, the electro-mechanical solenoid 182 is energized. When energized, the electro-mechanical solenoid 182 overcomes the force of the spring and translates a shaft 190 vertically downward in the direction of arrow 192 in FIG. 8B. The shaft 190 is perpendicular to the clutch pin 186. The downward translation of the shaft 190 rotates the pivot arm 184 about a pivot point 220. The pivot arm 184 is an L-shaped bracket, which is affixed to the clutch assembly housing 194. In this embodiment, the pivot point 220 is a pin affixed to the clutch assembly housing 194. By translating downward, the shaft 190 provides torque into the pivot arm 184, which subsequently pivots about the pivot point 220. Torque at this pivot arm 184 is translated into axial motion of the clutch pin 186. Namely, the torque pushes the clutch pin 186 through the clutch housing aperture 196 and away from the clutch assembly housing 194. The clutch pin 186 extends a sufficient horizontal length through the clutch housing aperture 196 to engage the rotating ring gear 188. When the clutch pin 186 engages the rotating ring gear 188, the clutch pin 186 prevents the rotating ring gear 188 from rotating, which allows for torque to be transmitted to the drum. The electro-mechanical solenoid 182 can advantageously be activated via remote control, and/or via a phone application.

When the user stops activating the portable winch with the power in or power out operations, the electro-mechanical solenoid 182 is deenergized. When the electro-mechanical solenoid 182 is deenergized, the shaft 190 extends, via the spring, vertically upward from the electro-mechanical solenoid 182 in the direction of arrow 198 in FIG. 8A. This upward translation of the shaft 190 rotates the pivot arm 184 about pivot point 220. In response, the clutch pin 186 is pulled through the clutch housing aperture 196 and towards clutch assembly housing 194. As the clutch pin 186 is pulled through the clutch housing aperture 196, the clutch pin 186 disengages the rotating ring gear 188 of the gear train assembly 136. As the clutch pin 186 disengages the gear train assembly 136, the portable winch returns to the default free-spool state.

The clutch pin 186 may also include a first end 200 with a dovetail shape. For example, a dovetail shape may include an angled sidewall that flares outward to the front surface of clutch pin 186. As further detailed herein, the angled sidewall engages the rotating ring gear 188. In an alternative, the first end 200 can have a triangular shape, which provides an angled sidewall on only a portion of the clutch pin 186. The rotating ring gear 188 may include a plurality of complementary notches 202 to engage the dovetail shape of the first end 200 of the clutch pin 186. With such configuration, the rotating ring gear 188 provides a lateral force that pulls the clutch pin 186 away from the clutch assembly housing 194. In an example, the user stops activating the portable winch. After the user stops activating the portable winch, the clutch assembly 180 may respond dependent on various factors.

In one example, the user stops activating the portable winch. And, when the user stops activating the portable winch, there is no load exerted on the portable winch. In other words, there is no tension on the rope of the portable winch. In such situation, the automatic clutch assembly 180 disengages the gear train assembly 136. In particular, the electro-mechanical solenoid 182 becomes deenergized, and the spring causes the shaft 190 to extend vertically upward from the electro-mechanical solenoid 182 in the direction of arrow 198 in FIG. 8A. This upward translation of the shaft 190 pulls the clutch pin 186 through the clutch housing aperture 196 to disengage the rotating ring gear 188 of the gear train assembly 136. As the clutch pin 186 disengages the gear train assembly 136, the portable winch returns to the default free-spool state.

In another example, the user stops activating the portable winch and a load is exerted on the portable winch via the tension in the rope. Such tension provides a rotational force on the drum. The rotational force on the drum is translated to a rotational force on the rotating gear 188. While the clutch pin 186 prevents the rotating gear 188 from rotating, the rotating gear 188 translates the rotational force into a horizontal, lateral force in the direction of arrow 216 in FIG. 8B. However, in this situation, the load is below a predetermined load threshold. When the load is below the predetermined load threshold, the lateral force is not sufficient to maintain the clutch pin 186 in the engaged position. Accordingly, the clutch assembly 180 retracts the clutch pin 186 (as previously described), and the clutch pin 186 disengages the gear train assembly 136. Accordingly, the portable winch returns to the default free-spool state. Thus, when the user stops activating the portable winch and the load exerted on the portable winch is below the predetermined threshold load, the portable winch returns to a free-spool state.

In another example, the user stops activating the portable winch and a load is exerted on the portable winch via the tension in the rope. Again, the tension provides a rotational force on the drum, which is translated to a rotational force on the rotating gear 188. The clutch pin 186 prevents the rotating gear 188 from rotating, and the rotating gear 188 translates the rotational force into a horizontal, lateral force in the direction of arrow 216 in FIG. 8B. In this example, the load is above the predetermined threshold load. When the load is above the predetermined threshold load, the lateral force causes the clutch pin 186 to remain in the engaged position. In other words, even when a user stops activating the portable winch, the portable winch maintains its engaged state if the load is above the predetermined threshold load. If the load falls below the predetermined threshold load, the clutch assembly 180 disengages the gear assembly 180 and the portable winch returns to the free-spool state.

In various embodiments, the geometry of the clutch pin 186 and rotating ring gear 188 may be varied to change the predetermined threshold load. In an example, the predetermined threshold load may be 20 lbs. Thus, turning back to the above description, the portable winch will stay safely in the engaged position when a load on the portable winch is above 20 lbs. However, if the load is below 20 lbs., the clutch pin 196 will retract into the clutch assembly housing 194 and the portable winch will return to its default of the free-spool state. In another example, the first end 200 of the clutch pin 186 may engage one of the plurality of complementary notches 202 at a greater angle. Accordingly, with an identical amount of rotational force on the rotating ring gear 188, the rotating ring gear 188 would exert a larger amount of lateral force on the clutch pin 186 in the direction of arrow 216. Thus, the predetermined threshold load may increase, for example, from 20 lbs. to 40 lbs. Likewise, the first end 200 of the clutch pin 186 may engage one of the plurality of complementary notches 202 at lesser angle. With an identical amount of rotational force on the rotating ring gear 188, the rotating ring gear 188 would exert a smaller amount of lateral force on the clutch pin 186 in the direction of arrow 216.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An automatic clutch assembly, comprising:
an electro-mechanical solenoid having a shaft disposed therein;
a pivot arm hingedly coupled to the electro-mechanical solenoid; and
a clutch pin disposed perpendicular to the shaft and coupled to the pivot arm, wherein the clutch pin is in an engaged position when the electro-mechanical solenoid is activated, and wherein the clutch pin is in a disengaged position when the electro-mechanical solenoid is deactivated.

2. The automatic clutch assembly of claim 1, wherein a first end of the pivot arm is coupled to the shaft of the electro-mechanical solenoid and a second end of the pivot arm is coupled to the clutch pin.

3. The automatic clutch assembly of claim 2, wherein the shaft is extended from the electro-mechanical solenoid when the electro-mechanical solenoid is deactivated.

4. The automatic clutch assembly of claim 3, wherein the shaft is retracted into the electro-mechanical solenoid when the electro-mechanical solenoid is activated.

5. The automatic clutch assembly of claim 4, further comprising a spring to mechanically bias the clutch pin to the disengaged position when the electro-mechanical solenoid is deactivated.

6. The automatic clutch assembly of claim 5, wherein the pivot arm rotates about a pin.

7. The automatic clutch assembly of claim 1, wherein the clutch pin extends through an aperture of the automatic clutch assembly.

8. The automatic clutch assembly of claim 1, wherein vertical translation of the shaft causes horizontal translation of the clutch pin.

9. The automatic clutch assembly of claim 1, wherein the clutch pin includes a first end and a second end, wherein the first end is coupled to the pivot arm.

10. The automatic clutch assembly of claim 9, wherein the second end of the clutch pin is a dovetail shape.

11. An automatic clutch assembly, comprising:
a pivot arm coupled to an electro-mechanical solenoid; and
a clutch pin having an engaged position and a disengaged position, wherein, in the engaged position, the clutch pin engages a gear assembly.

12. The automatic clutch assembly of claim 11, wherein the clutch pin extends through an aperture of the automatic clutch assembly to engage the gear assembly.

13. The automatic clutch assembly of claim 12, wherein the clutch pin engages a rotating gear of the gear assembly when the clutch pin is in the engaged position.

14. The automatic clutch assembly of claim 13, wherein the clutch pin includes a first end coupled to the pivot arm and a second end, wherein the second end engages the rotating gear of the gear assembly when the clutch pin is in the engaged position.

15. The automatic clutch assembly of claim 14, wherein the rotating gear of the gear assembly includes a plurality of notches.

16. The automatic clutch assembly of claim 15, wherein the second end of the clutch pin engages one of the plurality of notches of the rotating gear when the clutch pin is in the engaged position.

17. The automatic clutch assembly of claim 16, wherein, when the second end of the clutch pin engages one of the plurality of notches of the rotating gear, the one of the plurality of notches is configured to translate a rotational force on the rotating gear to a lateral force on the clutch pin.

18. The automatic clutch assembly of claim 17, wherein, when the lateral force is above a predetermined threshold load, the clutch pin maintains engagement with the rotating gear.

19. The automatic clutch assembly of claim 18, wherein, when the lateral force is below the predetermined threshold load, the clutch pin disengages from the rotating gear.

20. The automatic clutch assembly of claim 19, wherein the second end of the clutch pin is a dovetail shape.
